(19) United States
(12) Patent Application Publication
(10) Pub. No.: US 2014/0378579 A1
(43) Pub. Date: Dec. 25, 2014

(54) THERMOSETTING RESIN COMPOSITIONS

(71) Applicant: DSM IP ASSETS B.V., Heerlen (NL)

(72) Inventors: Giacomo Perfetti, Echt (NL); Johan Franz Gradus Antonius Jansen, Echt (NL); Bahri Widjanarko, Echt (NL)

(73) Assignee: DSM IP Assets B.V., Heerlen (NL)

(21) Appl. No.: 14/383,005

(22) PCT Filed: Mar. 11, 2013
(86) PCT No.: PCT/EP2013/054869

§ 371 Date: Sep. 4, 2014

(30) Foreign Application Priority Data
Mar. 12, 2012 (EP) 12159040

(51) Int. Cl. C08L 35/00

(52) U.S. Cl. CPC C08L 35/00; C08L 2205/03; C08L 2207/53
USPC 523/436; 525/120; 523/435

(57) ABSTRACT

The present invention relates to a thermosetting resin composition comprising (A) An unsaturated polyester resin comprising fumaric acid building blocks and/or a methacrylate functional resin, whereby the resin has a molecular weight Mₙ of from 450 up to and including 10000 Dalton and the amount of such unsaturated polyester resin and methacrylate functional resin is from 30 up to and including 80 wt. %; (B) An ethylenically unsaturated compound copolymerizable with (A); present in an amount from 10 up to and including 60 wt. %; (C) A core-shell rubber in an amount from 0.1 up to 6 wt. %, whereby the core has a T_{g} of less than −30° C. and the average particle diameter of the core-shell rubber is from 50 up to and including 1000 nm; and (D) An epoxy compound in an amount from 0.3 up to and including 10 wt. %; whereby the amounts are given relative to the total weight (in g) of the summed amount of (A), (B), (C) and (D).

The present invention relates to a thermosetting resin composition, curable via free radical polymerization, comprising (A) an unsaturated polyester resin comprising fumaric acid building blocks as unsaturated dicarboxylic acid building blocks and/or a methacrylate functional resin and (B) an ethylenically unsaturated compound copolymerizable with (A).

Thermosetting resin compositions harden by chemical reaction, often generating heat when they are formed, and cannot be melted or readily re-formed once hardened. The resin compositions are liquids at normal temperatures and pressures, so can be used to impregnate reinforcements, for instance fibrous reinforcements, especially glass fibers, and/or fillers may be present in the resin composition, but, when treated with suitable radical forming initiators, the various unsaturated components of the resin composition crosslink with each other via a free radical copolymerization mechanism to produce a hard, thermoset plastic mass (also referred to as structural part).

Thermosetting resin compositions are widely known and used examples thereof are unsaturated polyester resin dissolved in styrene and methacrylate functional resins dissolved in styrene. Due to their good mechanical properties they are employed in a wide variety of applications such as for instance, tanks, boats, relining, wind turbine blades, automotive parts, chemical anchoring etc.

Although for many applications the mechanical properties of the cured materials or their fiber reinforced laminates are good enough, there are still application areas for which further improvement is needed. An example of such an application area which still needs improvement is the wind turbine blade industry. In this industry there is a high requirement on the strength properties of the fibre reinforced laminate and in particular on transversal flexural strength and transversal tensile strength as they might correlate to an improvement in dynamic fatigue behavior.

Accordingly, the object of the present invention is to be able to increase the transversal flexural and tensile strength of fiber reinforced laminates of cured thermosetting unsaturated polyester resin or methacrylate resin compositions.

The object has been achieved in that the thermosetting resin composition comprising
(A) An unsaturated polyester resin comprising fumaric acid building blocks as unsaturated dicarboxylic acid building blocks and/or a methacrylate functional resin, whereby said resin has a molecular weight Mₙ of from 450 up to and including 10000 Dalton and the amount of such unsaturated polyester resin and methacrylate functional resin is from 30 up to and including 80 wt. %;
(B) An ethylenically unsaturated compound copolymerizable with (A); present in an amount from 10 up to and including 60 wt. %;
(C) A core-shell rubber in an amount from 0.1 up to 6 wt. %, whereby the core has a T_{g} of less than −30° C. and the average particle diameter of the core-shell rubber is preferably from 50 up to and including 1000 nm; and
(D) An epoxy compound in an amount from 0.3 up to and including 10 wt. %, which epoxy compound is liquid at room temperature,
   whereby the amounts are given relative to the total weight (in g) of the summed amount of (A), (B), (C) and (D).

It has surprisingly been found that the fracture toughness of fiber reinforced laminates of the cured thermosetting resin compositions of the invention can be increased, whilst at the same time the transversal flexural and tensile strength of the fibre reinforced laminate can be increased. This is surprising since adding a core shell rubber (C) and an epoxy compound (D) to a resin composition comprising (A) and (B) results in that the tensile strength of the cured, unreinforced resin composition (casting) remains at more or less the same level, while the flexural strength, of a fibre reinforced laminate obtained by impregnating fibres with such resin composition, can be increased, and even more surprising is that the transversal flexural strength and transversal tensile strength, of a fibre reinforced laminate obtained by impregnating fibres with such resin composition, can be significantly increased.

An additional surprising advantage is that the elongation at break and the fracture toughness of the cured, unreinforced composition (casting) can be increased while the tensile strength and modulus are maintained on an acceptable level. This is advantageous since a too low elongation at break and fracture toughness may result in that the structural part easily breaks. There is thus a desire to increase the fracture toughness and the elongation at break, however without sacrificing too much tensile strength and modulus since these properties are essential characteristics for structural parts obtained by curing thermosetting resin compositions. It is generally known that the presence of a rubber increases the fracture toughness. However, this does not mean that the elongation at break increases as there is no direct link between fracture toughness and elongation at break. In addition, the presence of a rubber generally results in a decrease of strength and modulus. It has surprisingly been found that with the thermosetting resin composition according to the invention, the elongation at break and the fracture toughness of the cured, unreinforced composition can be increased while the tensile strength and modulus are maintained on an acceptable level.

The thermosetting resin composition according to the invention comprises at least one α,β-ethylenically unsaturated polyester resin comprising fumaric acid building blocks and/or at least one methacrylate functional resin (compound (A)).

In a preferred embodiment of the invention, the thermosetting resin composition according to the invention comprises at least one methacrylate functional resin. In a more preferred embodiment, the resin present in the thermosetting resin composition is a methacrylate functional resin or a mixture of methacrylate functional resins.

The unsaturated polyester resin comprising fumaric acid building blocks and the methacrylate functional resins that may be present in the resin compositions according to the present invention, may suitably be selected from the unsaturated polyester resins and methacrylate functional resins as are known to the skilled man. Unsaturated polyester resin and methacrylate functional resins are characterised by having carbon-carbon unsaturations which are in conjugation with a carbonyl bond. Examples of suitable unsaturated polyester to be used in the resin composition of the present invention are described in M. Malik et al. in J.M.S. —Rev. Macromol. Chem. Phys., C40(2&3), p.139-165 (2000).

Methacrylate functional resin may suitably be selected from the methacrylate functional resins as are known to the skilled man. Methacrylate functional resins having unsaturated sites only in the terminal position are for example prepared by reaction of epoxy oligomers or polymers (e.g. diglycidyl ether of bisphenol-A, epoxies of the phenol-novolac type, or epoxies based on tetrabromobisphenol-A) with for example methacrylic acid. Instead of methacrylic acid also methacrylamide may be used. As used herein, a methacrylate functional resin is an oligomer or polymer containing at least one methacrylate functional end group. This also includes the class of vinyl ester urethane resins (also referred to as urethane methacrylate resins). Preferred methacrylate functional resins are methacrylate functional resins obtained by reaction of an epoxy oligomer or polymer with methacrylic acid or methacrylamide, preferably with methacrylic acid. Most preferred methacrylate functional resins are resins obtained by reaction of an epoxy oligomer or polymer with methacrylic acid.

The unsaturated polyester resin and the methacrylate functional resin as may be comprised in the resin composition according to the invention preferably has a molecular weight Mₙ in the range from 500 up to and including 5000 Dalton, more preferably in the range from 750 up to and including 4000. As used herein, the molecular weight Mₙ of the resin is determined in tetrahydrofurane using gel permeation chromatography according to ISO 13885-1 employing polystyrene standards and appropriate columns designed for the determination of the molecular weights. The unsaturated polyester resin preferably has an acid value in the range from 5 to 80 mg KOH/g resin, more preferably in the range from 10 to 70 mg KOH/g resin. As used herein, the acid value of the resin is determined titrimetrically according to ISO 2114-2000. The methacrylate functional resin preferably has an acid value in the range from 0 to 50 mg KOH/g resin.

The total amount of unsaturated polyester resin and methacrylate functional resin (A) having a molecular weight Mₙ of from 450 up to and including 10000 Dalton being present in the thermosetting resin composition according to the invention is from 30 up to and including 80 wt. %, preferably from 40 up to and including 80 wt. %. As described herein, the wt. % are, unless stated differently, based on the total weight of unsaturated polyester resin and methacrylate functional resin, ethylenically unsaturated monomers copolymerizable with said unsaturated polyester resin and/or methacrylate functional resin, core-shell rubber and epoxy compound (=(A)+(B)+(C)+(D)).

The ethylenically unsaturated compound (B) copolymerizable with said α,β-ethylenically unsaturated polyester and/or methacrylate functional resin can be any unsaturated monomer copolymerizable with (A). These ethylenically unsaturated compounds (B) are further relevant for reducing the viscosity of the thermosetting composition in order to improve the resin handling properties, particularly for being used in techniques like vacuum infusion, etc. As such, the ethylenically unsaturated compounds (B), able to copolymerize with (A), are able to dilute (A). As used herein, compounds (B) are able to dilute (A) means that mixing compounds (B) in an amount as present in the resin composition to compounds (A) in amounts as present in the resin composition lowers the viscosity, at 23° C. and atmospheric pressure, of compounds (A). The amount of such reactive diluent in the resin composition according to the invention can vary within wide ranges, however this depends on the type and reactivity of the ethylenically unsaturated compound copolymerizable with said α,β-ethylenically unsaturated polyester and/or methacrylate functional resin. The amount of ethylenically unsaturated compounds (B) copolymerizable with (A) (compounds (B) are also called reactive diluents) is generally from 10 up to and including 60 wt. %, preferably from 20 up to and including 60 wt. %.

Examples are, for instance, alkenyl aromatic monomer, such as for example styrene and divinylbenzene, vinyl toluene, t-butyl styrene, dialkyl itaconates, (meth)acrylates, vinyl ethers and vinyl amides but all other reactive monomers for use in the field of thermosetting resins as are known to the person skilled in the art can be used. Non-limited examples of reactive diluents are styrene, alpha-methyl styrene, chlorostyrene, vinyl toluene, divinyl benzene, methyl methacrylate, n-butyl methacrylate, cyclohexylmethacrylate, tert.butyl styrene, tert.butylacrylate, butanediol dimethacrylate, 2-hydroxypropyl methacrylate, 2-hydroxyethyl methacrylate, acetoacetoxyethyl methacrylate, PEG200 di(meth)acrylate, 1,4-butanediol di(meth)acrylate, 1,3-butanediol di(meth)acrylate, 2,3-butanedioldi(meth)acrylate, 1,6-hexanediol di(meth)acrylate and its isomers, diethyleneglycol di(meth)acrylate, triethyleneglycol di(meth)acrylate, glycerol di(meth)acrylate, trimethylolpropane di(meth)acrylate, neopentyl glycol di(meth)acrylate, dipropyleneglycol di(meth)acrylate, tripropyleneglycol di(meth)acrylate, PPG250 di(meth)acrylate, tricyclodecane dimethylol di(meth)acrylate, 1,10-decanediol di(meth)acrylate, tetraethylene glycol di(meth)acrylate and trimethylolpropanetri(meth)acrylate, dimethyl itaconate, diethyl itaconate, dibutyl itaconate and mixtures thereof. Preferably, the ethylenically unsaturated compound copolymerizable with (A) is selected from the group of styrene, substituted styrene and methacrylates or mixtures thereof. In one preferred embodiment, the ethylenically unsaturated compound copolymerizable with (A) is styrene. In another preferred embodiment, the ethylenically unsaturated compound copolymerizable with (A) is a methacrylate or a mixture of methacrylates.

The core-shell rubber is a particulate material having a rubbery core. The rubbery core preferably has a Tg of less than −30° C., more preferably less than −50° C. and even more preferably less than −70° C. Depending on the core, the Tg of the rubbery core may be well below −100° C. The core-shell rubber also has at least one shell portion that preferably has a Tg of at least 20° C. preferably at least 50° C. As used herein, the glass transition temperature T_{g} is determined using Differential Scanning calorimetry (DSC) according to ISO11357-2 (edition 1999) with a heating rate of 5° C./min. By “core”, it is meant an internal portion of the core-shell rubber. The core may form the center of the core-shell particle, or an internal shell or domain of the core-shell rubber. A shell is a portion of the core-shell rubber that is exterior to the rubbery core. The shell portion (or portions) typically forms the outermost portion of the core-shell rubber particle. The shell material is preferably grafted onto the core or is crosslinked. The rubbery core may constitute from 50 to 95%, especially from 60 to 90%, of the weight of the core-shell rubber particle.

The core of the core-shell rubber may be a homopolymer or copolymer of a conjugated diene such as butadiene, or a lower alkyl acrylate such as n-butyl-, ethyl-, isobutyl- or 2-ethylhexylacrylate.

In one preferred embodiment, the core of the core-shell rubber is a homopolymer or copolymer of a conjugated diene, preferably butadiene. The core polymer may in addition contain up to 20% by weight of other copolymerized monounsaturated monomers such as styrene, vinyl acetate, vinyl chloride, methyl methacrylate, and the like. The core polymer is optionally crosslinked. The core polymer optionally contains up to 5% of a copolymerized graft-linking monomer having two or more sites of unsaturation of unequal reactivity, such as diallyl maleate, monoallyl fumarate, allyl methacrylate, and the like, at least one of the reactive sites being non-conjugated.

In another preferred embodiment, the core polymer is a silicone rubber. These materials often have glass transition temperatures below −100° C. Core-shell rubbers having a silicone rubber core include those commercially available from Wacker Chemie, Munich, Germany, under the trade name Genioperl™.

The average particle diameter of the core-shell rubber is preferably from 50 up to and including 1000 nm and is more preferably less than 800 nm, more preferably less than 700 nm, more preferably less than 600 nm and even more preferably less than 400 nm. As used herein, the average particle diameter of the core-shell rubber is determined using Dynamic Light Scattering according to ISO 22412:2008.

The shell polymer, which is preferably chemically grafted and/or crosslinked to the rubber core, is preferably polymerized from at least one C1-C12 alkyl methacrylate, preferably C1-C4 alkyl methacrylate, such as methyl-, ethyl- or t-butyl methacrylate. Homopolymers of such methacrylate monomers can be used. Further, up to 40% by weight of the shell polymer can be formed from other monovinylidene monomers such as styrene, vinyl acetate, vinyl chloride, methyl acrylate, ethyl acrylate, butyl acrylate, and the like. The molecular weight of the grafted shell polymer is generally between 20000 and 500000 Dalton.

A preferred type of core-shell rubber has functional groups in the shell polymer which can react with the epoxy compound (C) and with at least one functional group of compound (A) and/or (B). Carboxyl groups, hydroxyl groups, carbon-carbon double bonds and glycidyl groups such as are provided by monomers such as glycidyl methacrylate are suitable.

A particularly preferred type of core-shell rubber is of the type described in EP 1 632 533 A1 and EP 2 258 773 A1. Core-shell rubber particles as described in EP 1 632 533 A1 and EP 2 258 773 A1 include a crosslinked rubber core, in most cases being a crosslinked copolymer of butadiene, and a shell which is preferably a copolymer of styrene, methyl methacrylate, glycidyl methacrylate and optionally acrylonitrile. The core-shell rubber is preferably dispersed in a polymer or more preferably in an epoxy compound (D) as described below.

Preferred core-shell rubbers include those sold by Kaneka Corporation under the designation Kaneka Kane Ace, including Kaneka Kane Ace MX 153 and Kaneka Kane Ace MX 257 core-shell rubber dispersions. The products contain the core-shell rubber particles pre-dispersed in an epoxy resin, at a concentration of approximately 33% respectively 37%. The epoxy resin contained in those products will form all or part of the epoxy compound (D) of the resin composition of the invention.

The amount of core-shell rubber particles (C) is preferably from 0.3 up to and including 5 wt. %, more preferably from 0.4 up to and including 3 wt. % relative to the total weight (in g) of the summed amount of (A), (B), (C) and (D).

The epoxy compound present in the resin composition according to the invention is preferably a diglycidyl ether, more preferably a bisphenol A or F diglycidyl ether and even more preferably a bisphenol A diglycidyl ether. The total amount of epoxy compounds (D) is preferably from 0.5 up to and including 8 wt. % and more preferably from 1 up to and including 6 wt. %, relative to the total weight (in g) of the summed amount of (A), (B), (C) and (D).

The weight amount of core-shell rubber (C) relative to the weight amount of epoxy compound (D) is preferably from 1:5 up to and including 5, more preferably from 1:1.2 up to and including 4, more preferably from 1:1.2 up to and including 3.

The thermosetting resin composition according to the invention preferably further comprises radical polymerization inhibitiors. By using these inhibitors it is possible to retard the radical polymerization process. These radical inhibitors are preferably chosen from the group of phenolic compounds, hydroquinones, catechols, benzoquinones stable radicals and/or phenothiazines. The amount of radical inhibitor that can be added may vary within rather wide ranges.

Suitable examples of radical inhibitors that can be used in the resin compositions according to the invention are, for instance, 2-methoxyphenol, 4-methoxyphenol, 2,6-di-t-butyl-4-methylphenol, 2,6-di-t-butylphenol, 2,4,6-trimethyl-phenol, 2,4,6-tris-dimethylaminomethyl phenol, 4,4′-thio-bis(3-methyl-6-t-butylphenol), 4,4′-isopropylidene diphenol, 2,4-di-t-butylphenol, 6,6′-di-t-butyl-2,2′-methylene di-p-cresol, hydroquinone, 2-methylhydroquinone, 2-t-butylhydroquinone, 2,5-di-t-butylhydroquinone, 2,6-di-t-butylhydroquinone, 2,6-dimethylhydroquinone, 2,3,5-trimethylhydroquinone, catechol, 4-t-butylcatechol, 4,6-di-t-butylcatechol, benzoquinone, 2,3,5,6-tetrachloro-1,4-benzoquinone, methylbenzoquinone, 2,6-dimethylbenzoquinone, napthoquinone, 1-oxyl-2,2,6,6-tetramethylpiperidine, 1-oxyl-2,2,6,6-tetramethylpiperidine-4-ol (a compound also referred to as TEMPOL), 1-oxyl-2,2,6,6-tetramethylpiperidine-4-one (a compound also referred to as TEMPON), 1-oxyl-2,2,6,6-tetramethyl-4-carboxyl-piperidine (a compound also referred to as 4-carboxy-TEMPO), 1-oxyl-2,2,5,5-tetramethylpyrrolidine, 1-oxyl-2,2,5,5-tetramethyl-3-carboxylpyrrolidine (also called 3-carboxy-PROXYL), galvinoxyl, aluminium-N-nitrosophenyl hydroxylamine, diethylhydroxylamine, phenothiazine and/or derivatives or combinations of any of these compounds.

According to a preferred embodiment the composition according to the invention comprises a stable radical more preferably a N-oxyl radical.

The thermosetting resin compositions according to the invention may further comprise chopped fibres. The thermosetting resin compositions according to the invention may further comprise pigments, fillers and/or low profile additives.

The present invention further relates to a multi-component resin system comprising at least two components (I) and (II), whereby component (I) comprises a thermosetting resin composition as described above and component (II) comprises a radical initiator (E). For initiating the radical copolymerization, a radical initiator, preferably a peroxide, is added to the resin composition optionally in combination with other compounds having a role in the radical initiation process, like for example compounds that accelerate the decomposition of the peroxide. Such compounds or some of such compounds may already be present in the resin composition prior to the addition of the peroxide. Preferably, the multi-component resin system further comprises an accelerator for the radical initiator which accelerator is present in component (I) and/or another component of the multi-component resin system but preferably not in component (II). Preferably, the multi-component resin system further comprises an inhibitor for the radical curing which inhibitor may be present in component (I), (II) and/or another component of the multi-component resin system.

In a preferred embodiment of the invention, the radical initiator system is the combination of at least one transition metal compound like for example Co, Cu, Mn, Fe compounds in combination with a hydroperoxide like for instance t-butyl hydroperoxide and cumenehydroperoxide, a perketal like for instance methyl ethyl ketone peroxide and acetylacetone peroxide, a perester like for instance t-butyl perbenzoate and a percarbonate, preferably in combination with an organic compound. The organic compound can be any organic compound that can be oxidized or reduced. Suitable examples are 1,2-dioxo compounds, 1,3-dioxo compounds, thiols, and N containing compounds like amides and amines. The preferred organic compound depends on the transition metal used. An example of a suitable 1,2-dioxo compound is butane-2,3-dione. Examples of suitable 1,3-dioxo compounds are acetylacetone, ethylacetoacetate and acetioacetamides like for instance N,N-diethylacetoacetamide. Examples of suitable amines are dimethylaniline, diethylaniline, dimethylparatoluidine, diethylhydroxylamine, benzyl amine, p-toluidine, 2-(N-ethylanilino)ethanol, triethanol amine, triethyl amine and Jeffamines, like for example Jeffamine D-2000. In case a cobalt compound is used, preferably at least one transition metal compound selected from the group consisting of copper, manganese and/or iron salts and/or complexes, is preferably also present in the multi-component resin system. In case a copper compound is used, preferably at least one transition metal compound selected from the group consisting of manganese and/or iron salts and/or complexes is also present in the multi-component resin system. In case a manganese compound is used, preferably at least one transition metal compound selected from the group consisting of copper and/or iron salts and/or complexes is also present in the multi-component resin system. In case an iron compound is used, preferably at least one transition metal compound selected from the group consisting of copper and/or manganese salts and/or complexes is also present in the multi-component resin system. The advantage of the further presence of such an additional transition metal compound is that the flexural strength and the transversal flexural strength of fibre reinforced composite article, as obtained by impregnating fibres with the multi-component resin system according to the invention and curing of the resin system, can be further increased. The amount of the additional transition metal compound is preferably from 0.01 up to and including 3 mmol per kg of the summed amount of (A), (B), (C) and (D), preferably from 0.02 up to and including 2 mmol per kg of the summed amount of (A), (B), (C) and (D) and more preferably from 0.04 up to and including 1.5 mmol per kg of the summed amount of (A), (B), (C) and (D).

Alternatively, in another embodiment of the invention, the radical initiator system is the combination of a tertiary aromatic amine like for instance N,N-dimethylaniline, N,N-diethylaniline, N,N-dimethylparatoluidine, N,N-diisopropyltoluidine with a peranhydride like for instance di benzoyl peroxide (BPO) or di lauroyl peroxide. In this embodiment, the radical initiator system preferably does not comprise a cobalt, copper, manganese and iron compound since the presence of such a transition metal compound negatively affect the curing of the resin composition.

The multi-component resin systems according to the invention can further comprise fibers. According to an embodiment of the invention, fiber reinforced composite articles are prepared via the process used for the preparation of fiber reinforced composite articles which is performed by mixing the components of the multi-component system, impregnating fibers with this mixture to obtain a resin system and allowing the resin system to cure.

The present invention thus further relates to the use of the multi-component resin system as described above to obtain fibre reinforced composite by mixing the components of the multi-component resin system as described above to obtain a mixture and impregnating fibres with said mixture. The amount of fibres is preferably from 20 up to 90 wt. %, more preferably from 40 up to 80 wt. %, relative to the amount (g) of said mixture. Glass fibres or carbon fibres are preferably used as fibres. In a preferred embodiment, the fibre reinforced composite is obtained by vacuum infusing the multi-component resin system of the invention into at least one fibre mat.

The present invention further relates to structural parts obtained by (i) mixing the components of the multi-component resin system according to the invention to obtain a mixture and (ii) impregnating fibres with said mixture to obtain a resin system and (iii) allowing the resin system to cure. According to a preferred embodiment of the invention, the impregnation of the fibers is effected with vacuum infusion. The viscosity of the mixture that is used for impregnating the fibers with vacuum infusion is preferably from 10 up to and including 400 mPa·s, more preferably from 20 up to and including 200 mPa·s (as measured according to according to ISO 3219 using Physica MC1 viscometer; spindle Z2 is used and the sample temperature is controlled at 23° C.). As used herein, this viscosity is determined on the mixture comprising all compounds except for the peroxide that is added shortly before the impregnation.

The present invention further relates to the use of such a structural part in for example automotive, boats, chemical anchoring, roofing, construction, containers, relining, pipes, tanks, flooring or wind turbine blades.

The invention is now demonstrated by means of a series of examples and comparative examples. All examples are supportive of the scope of claims. The invention, however, is not restricted to the specific embodiments as shown in the examples.

### Mechanical Testing of Castings:

Tensile modulus, tensile strength and elongation at break are measured according to ISO 527-2.
Flexural modulus and flexural strength are measured according to ISO 178.
Impact strength is measured according to ISO 179.
Fracture toughness (K_{IC} and G_{IC}) are measured according to ISO 17281.

### Mechanical Testing of Glass or Carbon Filled Laminates:

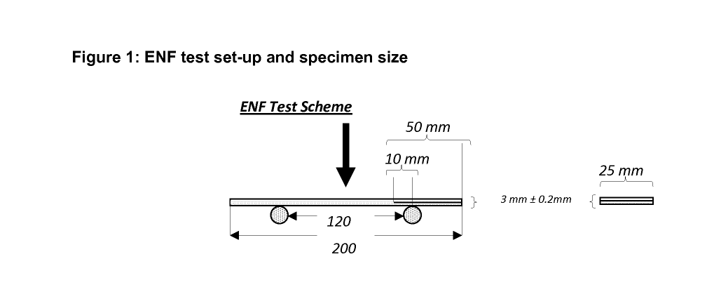

Flexural modulus and flexural strength at 0° direction (further mentioned flexural modulus and flexural strength) and outer fibre strain are measured with three-point flexural test according to ISO 14125.
Flexural modulus and flexural strength at 90° (transversal) direction are measured with three-point flexural test according to ISO 14125.
Tensile modulus, tensile strength and elongation at break at 90° (transversal) direction are measured according to ISO 527.
ENF (End-Notched Flexural) test is performed according to the following method. A laminate with a pre-crack is prepared as shown in FIG. 1 (width of the laminate is 25 mm). The pre-cracked area of the laminate is subjected to a shear load (see FIG. 1). This shear load is composed of tensile load on the bottom part and compression load on the upper part.
The pre-crack is obtained by inserting a Teflon film into the mid-plane of laminate prior to infusion. The test is performed using a Zwick/Roell material testing system with a loading rate of 1.3 mm/min. The interlaminar fracture toughness is characterized by the critical energy release rate (in mode II) G_{IIC}, determined according to formula 1

$$\begin{matrix}a & = & Crack length ( 10 mm ) \\ w & = & Specimen width ( 25 mm ) \\ h & = & Specimen thickness ( mm ) \\ E & = & Tensile modulus ( MPa ) \\ Fmax & = & Maximal force applied ( N ) \\ {G}_{IIC} & = & Critical energy release ( J \text{/} {m}^{2} ) \\ {G}_{llC} & = & \frac{9 \times a \times F {max}^{2}}{1000 [ 16 E \times {{w}^{2} [ \frac{h}{2} ]}^{3} ]}\end{matrix} \qquad ( 1 )$$

G_{IIC} value (interlaminar fracture toughness of laminated composites) value is related to the energy released during the separation of two layers. A high value of G_{IIC} is an indication of a strong interface.

### Preparation of Glass Filled Laminates

The glass filled laminates were prepared using vacuum infusion employing Saertex GE Wind UD combi fiber mats with the following composition 0° 864 g/m2 E glass, 90° 81 g/m2 E glass and 18 g/m2 polyester stitching. 4 layers of 45×45 cm² glass fiber mats are stacked in a (0°-90°+0°-90°+90°-0°+90°-0°) arrangement. Peel ply and flow mesh are used and the vacuum infusion is performed along the 0° axis using a vacuum of 1000 mbar. 30 minutes after the resin has reached the end of the laminate, the pressure is reduced to 600 mbar. After curing for 24 hrs at room temperature the laminates are post cured for 24 hours at 60° C.

### Preparation of Carbon Filled Laminates

The carbon filled laminates were prepared using RTM process employing Saertex mats based on unidirectional carbon fibre with the following composition 0° 410 g/m2 Toray T700 50C, ±45° 22 g/m2 E-glass and PES stitching and stacked in a (0°-±45°+±45°-0°+0°-±45°+)±45°-0° arrangement. Four (4) layers of carbon fibers (resulting in 49% V_{f} fiber volume) were placed into a 2 mm thickness RTM 60 Mould; the temperature of the upper mould was 90° C. and of the lower mould, 85° C. No release agent was applied on the surface of the mould due to the presence of the internal release agent into the resin. The final mixture was then injected into the mould under 4.5 bar pressure while 0.5 mbar vacuum was applied. The laminates were cured for 20 minutes and subsequently post cured for 4 hours at 120° C.

### Preparation of Castings

4 mm thick neat resin castings were prepared by casting the degassed resin formulations between two hardened borosilicate glass plates that are separated by a U-shaped 4 mm EPDM rubber. After curing overnight at room temperature, the castings were post-cured 24 hrs at 60° C.

### Materials Used

Atlac 430 is a methacrylate functional resin commercially available from DSM Composite Resins.
Epikote 828 is an epoxy resin commercially available from Hexion.
Kane Ace MX EXP257 and Kane Ace MX EXP153 are core shell rubbers dispersed in a bisphenol A epoxide and are commercially available from Kaneka Corporation.
Albidur 3320 and Albidur 3340 are core shell rubbers dispersed in a methacrylate functional resin and are commercially available from Nano Resins AG.
Byk A525, Byk A515 and Byk A 555 are release agents available from BYK Chemie.
Butanox LPT-IN and Trigonox 42PR are peroxides, NL-49P a cobalt carboxylate solution; all commercially available from Akzo Nobel.
Nuodex Cu-8 and Nuodex Mn-10 are metal carboxylate solutions in spirits (8 resp 10% metal) both commercially available from Rockwood.
Borchers Oxy coat 1101 is a 1% Fe complex solution in propylene glycol, commercially available from OMG.
Dragon A 350 is a manganese complex solution in propylene glycol (0.18% Mn), commercially available from Rahu Catalytics.
PAT672 is an internal mould release agent commercially available from Würtz.

### EXAMPLE 1 AND COMPARATIVE EXPERIMENTS A-C

All parts given are wt. parts.

To a mixture of 85 parts Atlac 430 and 15 parts styrene was added 0.15 parts Byk A515, 0.15 parts Byk A555, 0.2 parts NL-49P and various parts of either Epikote 828, pure core shell rubber (i.e. washed Kane Ace MX EXP257) or pure core shell rubber (i.e. washed Kane Ace MX EXP257) with Epikote 828.

After homogenization, 1 part Butanox LPT-IN was added, the mixture was degassed and castings and laminates were prepared as described above. The results are shown in table 1.

TABLE 1

| | Comp A | Comp B | Comp C | Exp1 |
|---|---|---|---|---|
| Atlac 430 + 15% extra | 100 | 100 | 100 | 100 |
| styrene | | | | |
| Epikote 828 | | 4 | | 4 |
| Pure core shell rubber of | | | 2 | 2 |
| Kaneka MX EXP 257 | | | | |
| Castings | | | | |
| K_{IC} (MPa*m⁻²) | 0.7 | 0.9 | 1.1 | 1.4 |
| G_{IC} (KJ/m²) | 0.3 | 0.6 | 0.9 | 1.5 |
| Tensile strength (MPa) | 72.8 | 73.4 | 75.7 | 70.7 |
| Tensile modulus (MPa) | 3635 | 3573 | 3417 | 3461 |
| E at break (%) | 3 | 2.46 | 4.32 | 5.57 |
| Impact strength (KJ/m²) | 17.1 | 22.0 | 16.8 | 30.2 |
| Laminates | | | | |
| Flex strength(GPa) | 0.8 | 1.2 | 1.3 | 0.9 |
| ENF max load (kN) | 1.3 | 1.5 | 1.6 | 1.6 |
| ENF G_{IIC} (kJ/m²) | 1.9 | 2.4 | 2.1 | 2.6 |
| Transversal flexural | 34.4 | 38.9 | 38.5 | 40.1 |
| strength (MPa) | | | | |
| Transversal flexural | 10.4 | 12.5 | 12.8 | 10.1 |
| modulus (GPa) | | | | |
| Transversal tensile | 26.5 | 29.6 | 31.6 | 34.2 |
| strength (MPa) | | | | |
| Transversal tensile | 15.1 | 13.4 | 12.4 | 12.9 |
| modulus (GPa) | | | | |
| Transversal tensile E at | 0.2 | 0.2 | 0.2 | 0.3 |
| Break (%) | | | | |

When adding a normal (not core-shell) rubber to the composition of Comp. Ex. A, the tensile strength would decrease to a value below 50 MPa. Comparing Comp Ex A and Ex 1 shows that adding the core shell rubber and the epoxy resin Epikote 828 to the methacrylate functional resin results in that the tensile strength of the casting remains more or less the same. Based on this, one would expect that the flexural strength of the laminate in Example 1 would remain more or less the same as in Comp Ex A. One would in particular also expect that the transversal flexural strength and transversal tensile strength of the laminate in Example 1 would decrease compared to Comp Ex A since these properties are measured in the weakest direction of the glass fibre reinforcement. However, surprisingly, the flexural strength, the transversal flexural strength and transversal tensile strength in the laminate are significantly increased when adding the core shell rubber and the epoxy resin Epikote 828 to the methacrylate functional resin.

Example 1 and the comparative experiments clearly demonstrate the surprising positive effect of adding both a core shell rubber and an epoxide on the mechanical properties of the fiber reinforced laminates according to the invention. The highest value of the interlaminar adhesion as described by the G_{IIC} (2.6 kJ/m²), the highest transversal tensile strength (34.2 GPa) and the highest transversal elongation at break (0.3%) is found in example 1. Only with the example according to the invention the combination of a flexural strength >0.9 GPa, a G_{IIC}>2.2 kJ/m², a transversal tensile strength >30 MPa and an elongation at break >0.2% of the laminate can be achieved.

### EXAMPLES 3-4 AND COMPARATIVE EXPERIMENTS D-E

To a mixture of 85 parts Atlac 430 and 15 parts styrene was added 0.15 parts Byk A515, 0.15 parts Byk 555, 0.2 parts NL-49P and various parts of dispersed core shell rubbers. After homogenization, 1 part Butanox LPT-IN was added, the mixture degassed and castings and laminates were prepared as described above. The results are shown in table 2.

TABLE 2

| | Example 2 | Example 3 | Comp D | Comp E |
|---|---|---|---|---|
| Atlac 430 + 15% extra styrene | 100 | 100 | 100 | 100 |
| Core shell rubber | | | | |
| Kaneka MX EXP 257 | 4 | | | |
| Kaneka MX EXP 153 | | 4.5 | | |
| Albidur 3320 | | | 7.4 | |
| Albidur 3340 | | | | 3.7 |
| Amount rubber | 1.48 | 1.48 | 1.48 | 1.48 |
| Type of the core | x-linked | x-linked | silicone | silicone |
| | polybutadiene | polybutadiene | | |
| Average particle diameter of | 200 | 100 | 800 | 800 |
| core shell rubber (nm) | | | | |
| Tg core ° C. | −75 | −75 | −100 | −100 |
| Amount epoxide diluent | 2.52 | 3.02 | | |
| Amount vinylester diluent | | | 5.92 | 2.22 |
| Castings | | | | |
| K_{IC} (MPa*m⁻²) | 1.3 | 1.0 | 1.2 | 0.9 |
| G_{IC} (KJ/m²) | 1.2 | 0.7 | 1.8 | 0.4 |
| Tensile strength (MPa) | 72 | 78 | 61 | 74 |
| Tensile modulus (GPa) | 3.4 | 3.5 | 2.9 | 2.9 |
| E at break (%) | 5.3 | 5 | 6.8 | 4.7 |
| Flexural strength (MPa) | 125.1 | 129 | 114.3 | 121 |
| Flexural Modulus (GPa) | 3.5 | 3.4 | 3.2 | 3.4 |
| Laminates | | | | |
| Flex strength(GPa) | 1.0 | 1.2 | 0.9 | 0.8 |
| Flexural modulus (GPa) | 42.4 | 33.7 | 39.1 | 35.3 |
| ENF max load (kN) | 1.6 | 1.7 | 1.7 | 1.5 |
| ENF G_{IIC} (kJ/M²) | 2.5 | 2.2 | 2.3 | 2.2 |
| Transversal flexural strength | 36.8 | 41 | 27.9 | 36 |
| (MPa) | | | | |
| Transversal flexural modulus | 9.7 | 11.3 | 7.3 | 9.4 |
| (GPa) | | | | |
| Transversal tensile strength | 32.5 | 32.2 | 22.5 | 23.3 |
| (MPa) | | | | |
| Transversal tensile modulus | 10.5 | 12.1 | 8.5 | 9.9 |
| (GPa) | | | | |
| Transversal tensile E at Break | 0.3 | 0.2 | 0.2 | 0.2 |
| (%) | | | | |
| Outer fibre strain (%) | 0.4 | 0.4 | 0.3 | 0.2 |

This table clearly demonstrates that the core shell rubbers should be dispersed in an epoxide and not in a methacrylate functional resin for obtaining the good mechanical properties. This is most clearly demonstrated by the effect on the transversal tensile strength.

### EXAMPLES 4-8

To a mixture of 85 parts Atlac 430 and 15 parts styrene was added 0.15 parts Byk A515, 0.15 parts Byk A555, 0.2 parts NL-49P (Cobalt) and 6 parts Kane Ace MX EXP257 and various amounts of other transition metal additives. After homogenization, 1 part Butanox LPT-IN was added, the mixture was degassed and castings and laminates were prepared as described above. The results are shown in table 3.

TABLE 3

| | Example | Example | Example | Example | Example |
|---|---|---|---|---|---|
| | 4 | 5 | 6 | 7 | 8 |
| Atlac 430 + 15% | 100 | 100 | 100 | 100 | 100 |
| extra styrene | | | | | |
| Rubber | | | | | |
| MX257 | 6 | 6 | 6 | 6 | 6 |
| Amount rubber | 2.22 | 2.22 | 2.22 | 2.22 | 2.22 |
| Amount epoxide | 3.78 | 3.78 | 3.78 | 3.78 | 3.78 |
| Other additives | | | | | |
| Nuodex Cu 8 | | 0.05 | | | |
| (8% Cu in spirits) | | | | | |
| Nuodex Mn 10 | | | 0.04 | | |
| (10% Mn in spirits | | | | | |
| Dragon A 350 | | | | 0.4 | |
| (0.18% Mn in | | | | | |
| propylene glycol) | | | | | |
| Borchers oxy | | | | | 0.4 |
| coat 1101 | | | | | |
| (1% Fe complex = | | | | | |
| 0.08% Fe in | | | | | |
| propylene glycol) | | | | | |
| mmol additives | | 0.63 | 0.73 | 0.13 | 0.057 |
| metal/kg resin | | | | | |
| Castings | | | | | |
| K_{IC} (MPa*m⁻²) | 1.4 | 1.7 | 1.7 | 1.4 | 1.7 |
| G_{IC} (KJ/m²) | 1.5 | 2.5 | 1.7 | 1.3 | 1.7 |
| Tensile strength | 70.7 | 70.7 | 73.0 | 70.5 | 71.6 |
| (MPa) | | | | | |
| Tensile modulus | 3.5 | 3.4 | 3.4 | 3.4 | 3.4 |
| (GPa) | | | | | |
| E at break (%) | 5.6 | 7.2 | 4.1 | 7.2 | 3.6 |
| Flexural strength | 0.1 | 0.1 | 0.1 | 0.1 | 0.1 |
| (GPa) | | | | | |
| Flexural Modulus | 3.2 | 3.4 | 3.3 | 3.4 | 3.3 |
| (GPa) | | | | | |
| Laminate | | | | | |
| Flex strength (GPa) | 0.9 | 1.2 | 1.2 | 1.4 | 1.1 |
| ENF max load (kN) | 1.6 | 1.9 | 1.9 | 1.7 | 1.9 |
| ENF G_{IIC} (kJ/M²) | 2.6 | 2.8 | 2.6 | 2.3 | 2.6 |
| Transversal flexural | 40.1 | 51.7 | 48.6 | 46.7 | 45.1 |
| strength (MPa) | | | | | |
| Transversal flexural | 10.1 | 11.8 | 11.2 | 12.6 | 10.4 |
| modulus (GPa) | | | | | |
| Transversal tensile | 34.2 | 36.9 | 34.7 | 38.2 | 36.9 |
| strength (MPa) | | | | | |
| Transversal tensile | 12.9 | 13.5 | 13.5 | 13.3 | 13.0 |
| modulus (GPa) | | | | | |
| Transversal tensile | 0.3 | 0.3 | 0.3 | 0.3 | 0.3 |
| E at Break (%) | | | | | |
| Outer fibre strain | 0.4 | 0.4 | 0.5 | 0.4 | 0.4 |
| (%) | | | | | |

This table clearly shows the beneficial effect of adding small amount of an additional transition metal salt or complex selected from the group of Mn, Fe or Cu to the Co containing formulation on the flexural strength of the laminate as well as on the transversal flexural strength of the laminate (compare example 4 with 5-8). This is the more surprising since the addition of a small amount of an additional transition metal salt or complex selected from the group of Mn, Fe or Cu does not have a beneficial effect on the flexural strength of the casting.

### EXAMPLE 9-17 AND COMPARATIVE EXPERIMENT F

To a mixture of 85 parts Atlac 430 and 15 parts styrene were added 0.15 parts Byk A515, 0.15 parts Byk A555, 0.2 parts NL-49P and various amounts of dispersed core shell rubbers. After homogenization, 1 part Butanox LPT-IN was added, the mixture degassed and castings and laminates were prepared as described above. The results are shown in table 4.

TABLE 4

| | | | | | | | | | | Comp |
|---|---|---|---|---|---|---|---|---|---|---|
| | Ex 9 | 10 | 11 | 12 | 13 | 14 | 15 | 16 | 17 | F |
| Atlac 430 + 15% | 100 | 100 | 100 | 100 | 100 | 100 | 100 | 100 | 100 | 100 |
| extra styrene | | | | | | | | | | |
| Rubber | | | | | | | | | | |
| MX257 | 2 | 4 | 6 | | | | 2 | 4 | 6 | |
| MX153 | | | | 2 | 4 | 6 | | | | |
| Amount rubber | 0.74 | 1.48 | 2.22 | 0.66 | 1.33 | 2 | 0.74 | 1.48 | 2.22 | |
| Amount epoxide | 1.26 | 2.52 | 3.78 | 1.34 | 2.67 | 4 | 1.26 | 2.52 | 3.78 | |
| Nuodex Cu 8 | | | | | | | 0.05 | 0.05 | 0.05 | |
| Castings | | | | | | | | | | |
| K_{IC} (MPa*m⁻²) | 1.1 | 1.3 | 1.4 | 1.0 | 1.0 | 1.1 | 1.2 | 1.3 | 1.7 | 0.7 |
| G_{IC} (KJ/m²) | 0.9 | 1.2 | 1.5 | 0.5 | 0.7 | 0.9 | 0.8 | 0.8 | 2.5 | 0.3 |
| Tensile strength | 74.4 | 71.5 | 70.7 | 75.2 | 78.3 | 77.9 | 73.1 | 74.1 | 70.7 | 72.8 |
| (MPa) | | | | | | | | | | |
| Tensile modulus | 3.4 | 3.4 | 3.5 | 3.5 | 3.5 | 3.4 | 3.4 | 3.5 | 3.4 | 3.6 |
| (GPa) | | | | | | | | | | |
| E at break (%) | 4.1 | 4.9 | 5.6 | 3.2 | 5.0 | 5.2 | 4.36 | 5.2 | 7.2 | 3 |
| Flexural strength | 126 | 125 | 123 | 123 | 129 | 129 | 126 | 130 | 124 | 113 |
| (MPa) | | | | | | | | | | |
| Flexural Modulus | 3.4 | 3.5 | 3.3 | 3.3 | 3.4 | 3.4 | 3.2 | 3.5 | 3.4 | 3.1 |
| (GPa) | | | | | | | | | | |
| Impact strength | 18.9 | 18.3 | 30.2 | 17.2 | 18.6 | 22.2 | 21.1 | 21.1 | 29.8 | 17.1 |
| (KJ/m² | | | | | | | | | | |
| Laminates | | | | | | | | | | |
| Flex strength | 1.0 | 1.0 | 0.9 | 1.2 | 1.2 | 1.2 | 1.2 | 1.2 | 1.3 | 0.8 |
| (GPa) | | | | | | | | | | |
| Flex modulus | 40.4 | 42.4 | 39.8 | 30.7 | 33.7 | 35.5 | 33.1 | 33.5 | 30.7 | 31.2 |
| (GPa) | | | | | | | | | | |
| ENF max | 1.6 | 1.6 | 1.6 | 1.7 | 1.7 | 1.7 | 1.8 | 1.9 | 1.9 | 1.3 |
| load (kN) | | | | | | | | | | |
| ENF G_{IIC} | 2.4 | 2.4 | 2.6 | 2.3 | 2.2 | 2.4 | 2.4 | 2.5 | 2.8 | 1.9 |
| (kJ/M²) | | | | | | | | | | |
| Transversal | 36.6 | 36.8 | 40.1 | 46.5 | 41.4 | 37.4 | 40.4 | 45.6 | 51.6 | 34.4 |
| flexural strength | | | | | | | | | | |
| (MPa) | | | | | | | | | | |
| Transversal | 9.1 | 9.7 | 10.1 | 11.3 | 11.2 | 12.2 | 11.9 | 11.6 | 11.8 | 10.4 |
| flexural modulus | | | | | | | | | | |
| (GPa) | | | | | | | | | | |
| Transversal | 30.2 | 32.5 | 34.2 | 31.8 | 32.2 | 37.2 | 34.4 | 36.5 | 36.9 | 26.5 |
| tensile strength | | | | | | | | | | |
| (MPa) | | | | | | | | | | |
| Transversal | 11.4 | 10.5 | 12.9 | 13.1 | 12.2 | 14.2 | 12.3 | 13.4 | 13.5 | 15.1 |
| tensile modulus | | | | | | | | | | |
| (GPa) | | | | | | | | | | |
| Transversal | 0.3 | 0.3 | 0.3 | 0.2 | 0.2 | 0.3 | 0.3 | 0.3 | 0.3 | 0.2 |
| tensile E at Break | | | | | | | | | | |
| (%) | | | | | | | | | | |
| Outer fibre strain | 0.3 | 0.4 | 0.4 | 0.4 | 0.4 | 0.3 | 0.3 | 0.4 | 0.4 | 0.2 |
| (%) | | | | | | | | | | |

The examples clearly demonstrate that various amount of core shell rubbers combined with various amounts of diluents can be used according to the invention

### EXAMPLE 18 AND COMPARATIVE EXPERIMENT G

To 100 parts Atlac 430 was added various additives (see table). After homogenization the peroxide (Trigonox 42PR) was added and the mixture degassed. Laminates were prepared with RTM (Resin Transfer Moulding) using 4 layers of unidirectional carbon fibers (surface weight 438 g/m2) which were post cured for 4 hrs at 120° C.

The results are shown in table 5.

TABLE 5

| | Comp G | Ex 18 |
|---|---|---|
| Atlac 430 | 100 | 100 |
| styrene | | 5 |
| Byk A 525 | 0.2 | 0.2 |
| Byk A 555 | 0.2 | 0.2 |
| PAT 672 | 1 | 1 |
| Rubber | | |
| MX257 | | 6 |
| Amount rubber | | 2.22 |
| Amount epoxide | | 3.78 |
| Nuodex Cu 8 | | 0.05 |
| Cure | | |
| NL-49P | 0.1 | 0.5 |
| Trigonox 42PR | 1 | 1 |
| Laminates | | |
| Flexural strength 0° (MPa) | 1329 | 1245 |
| Flexural modulus 0° | 100 | 97 |
| Flexural strength 90° (MPa) | 54 | 83 |
| Tensile modulus 90° | 6.9 | 6.5 |
| G_{IC} (J/m²) | 864 | 1059 |
| G_{IIC} (J/m²) | 3707 | 4963 |

This example shows that besides glass fibers also carbon fibers can be used.

1. Thermosetting resin composition comprising
(A) An unsaturated polyester resin comprising fumaric acid building blocks and/or a methacrylate functional resin, whereby the resin has a molecular weight Mₙ of from 450 up to and including 10000 Dalton and the amount of such unsaturated polyester resin and methacrylate functional resin is from 30 up to and including 80 wt. %;
(B) An ethylenically unsaturated compound copolymerizable with (A);
present in an amount from 10 up to and including 60 wt. %;
(C) A core-shell rubber in an amount from 0.1 up to 6 wt. %, whereby the core has a T_{g} of less than −30° C. and the average particle diameter of the core-shell rubber is from 50 up to and including 1000 nm; and
(D) An epoxy compound in an amount from 0.3 up to and including 10 wt. %;
whereby the amounts are given relative to the total weight (in g) of the summed amount of (A), (B), (C) and (D).

2. Thermosetting resin composition according to claim 1, wherein the core of the core-shell rubber is a homopolymer or copolymer of a conjugated diene, preferably butadiene.

3. Thermosetting resin composition according to claim 1, wherein the core of the core-shell rubber is a silicone rubber.

4. Thermosetting resin composition according to claim 1, wherein the shell of the core-shell rubber is a polymer polymerized from at least one C1-C12 alkyl methacrylate, preferably C1-C4 alkyl methacrylate.

5. Thermosetting resin composition according to claim 1, wherein the shell of the core-shell rubber is chemically grafted and/or crosslinked to the rubber core.

6. Thermosetting resin composition according to claim 1, wherein the shell of the core-shell rubber contains at least one functional group reactive with a functional group of compound (A) and/or (B).

7. Thermosetting resin composition according to claim 6, wherein the reactive functional group is a glycidyl group, a carboxyl group, a hydroxyl group or a carbon-carbon double bond.

8. Thermosetting resin composition according to claim 1, wherein the average particle diameter of the core-shell rubber is less than 800 nm, preferably less than 700 nm, more preferably less than 600 nm and even more preferably less than 400 nm.

9. Thermosetting resin composition according to claim 1, wherein the amount of core-shell rubber (C) is from 0.3 up to and including 5 wt. %, more preferably from 0.4 up to and including 3 wt. % relative to the total weight (in g) of the summed amount of (A), (B), (C) and (D).

10. Thermosetting resin composition according to claim 1, wherein the resin present in the thermosetting resin composition is a methacrylate functional resin or a mixture of methacrylate functional resins.

11. Thermosetting resin composition according to claim 1, wherein the amount of epoxy compound (D) is from 0.5 up to and including 8 wt. %, preferably from 1 up to and including 6 wt. %, relative to the total weight (in g) of the summed amount of (A), (B), (C) and (D).

12. Thermosetting resin composition according to claim 1, wherein the epoxy compound is a diglycidyl ether, preferably bisphenol A or F diglycidyl ether, more preferably bisphenol A diglycidyl ether.

13. Thermosetting resin composition according to claim 1, wherein the weight amount of core-shell rubber (C) relative to the weight amount of epoxy compound (D) is from 1:5 up to and including 5, more preferably from 1:1.2 up to and including 4, more preferably from 1:1.2 up to and including 3.

14. Thermosetting resin composition according to claim 1, wherein the thermosetting resin composition comprises styrene or methacrylate(s) as ethylenically unsaturated compound copolymerizable with (A).

15. Multi-component resin system comprising at least two components (I) and (II), whereby component (I) comprises a thermosetting resin composition according to claim 1 and component (II) comprises a radical initiator (E).

16. Multi-component resin system according to claim 15, wherein the multi-component resin system comprises a cobalt compound and further a transition metal compound selected from Cu, Mn and Fe compounds and mixtures thereof.

17. Structural part obtained by (i) mixing the components of the multi-component resin system according to claim 15 to obtain a mixture and (ii) impregnating fibres with said mixture to obtain a resin system and (iii) allowing the resin system to cure.

18. Use of the structural part according to claim 17 in automotive, boats, chemical anchoring, roofing, construction, containers, relining, pipes, tanks, flooring or wind turbine blades.
